(19) United States
(12) Patent Application Publication
(10) Pub. No.: US 2026/0264576 A1
(43) Pub. Date: Sep. 10, 2026

(54) GEAR ASSEMBLY, DRIVE AND ADJUSTMENT DEVICE FOR A MOTOR VEHICLE

(71) Applicant: IMS Gear SE & Co. KGaA, Donaueschingen (DE)

(72) Inventors: Gabriel FUCHS, Brigachtal (DE); Manuel HENGSTLER, Georgen (DE); Johannes WEINERT, VS-Schwenningen (DE)

(21) Appl. No.: 19/384,972

(22) Filed: Nov. 10, 2025

(30) Foreign Application Priority Data
Nov. 11, 2024 (EP) 24212240.6

(51) Int. Cl. B60N 2/02

(52) U.S. Cl. CPC B60N 2/02253

(57) ABSTRACT

Gear assembly (10) with a gear (14) and at least one thrust washer (30, 32) with a substantially annular thrust surface (54), wherein the gear (14) has an axis of rotation (16) and a toothing (18) running around the axis of rotation (16) with teeth (22) and tooth spaces (24) arranged alternately in a circumferential direction (20) around the axis of rotation (16), wherein the toothing (18) has at least one axial end face (34, 36) with a recess (38) extending around the axis of rotation (16), the at least one thrust washer (30, 32) having at least one washer projection (56) projecting radially beyond the thrust surface (54), and being arranged in the recess (38) in such a way that the at least one washer projection (56) is arranged to engage radially in one of the tooth spaces (24) in each case, and Drive (72) with a gear assembly (10), and Adjustment device for a motor vehicle, in particular for a motor vehicle seat.

The invention relates to a gear assembly, a drive with such a gear assembly and an adjustment device for a motor vehicle.

Seat fore-and-aft adjustment devices are often used for the electromotive fore-and-aft adjustment of seats in motor vehicles. The seat fore-and-aft adjustment devices often have a spindle gear by means of which the speed and torque are transmitted between a drive worm and a drive gear spindle. For this purpose, a spindle nut is arranged on the drive gear spindle, which in turn has a ring gear with external teeth that meshes with the drive worm.

Plain bearings, which are arranged on bearing seats of the spindle nut axially adjacent to the external toothing, are usually used to support the spindle nut. Particularly in the case of external gearing designed as helical gearing, it is necessary to support the spindle nut appropriately with regard to the axial forces occurring in the axial direction. An axial thrust surface must therefore be provided on the spindle nut, which is designed to form a sliding contact with a plain bearing. In order to provide such a thrust surface on the axial end faces of the external gearing, it is state of the art to cover the axially open external gearing with a thrust washer. To ensure that the sliding contact between the plain bearing and the thrust washer is defined, the thrust washer must be mounted on the spindle nut so that it cannot rotate. Various solutions are known for securing the thrust washer against rotation in relation to the spindle nut.

DE 10 2013 207 665 A1 , for example, suggests pressing the thrust washer onto the spindle nut. However, the disadvantage of this is that pressing on can lead to chip removal and deformation of the thrust washer. Both can result in premature failure of the drive. It is known from KR 101 920 222 B1 to provide a thrust washer with an axial projection that can engage in the axial direction between two teeth of the external toothing. The disadvantage of this solution is that the production of the thrust washer is relatively complex.

The thrust washer shown in DE 103 62 040 B4 has a radial projection that is bent in the axial direction after the thrust washer is arranged on the spindle nut and can thus engage in the axial direction between two teeth of the external toothing. A disadvantage of this system is that an additional manufacturing step is required to bend the radial projection when arranging the thrust washer on the spindle nut.

The invention is therefore based on the task of providing a gear assembly in which the thrust washer can be simply and securely arranged on the end face of the toothing. The invention is also based on the task of providing a corresponding drive and a corresponding adjustment device for a motor vehicle.

In accordance with the invention, the tasks are solved by a gear assembly with the features of patent claim 1, a drive with the features of patent claim 12 and an adjustment device with the features of patent claim 15.

Advantageous designs and further embodiments of the invention are given in the dependent claims.

A gear assembly according to the invention comprises a gear and at least one thrust washer with a substantially annular thrust surface, wherein the gear has an axis of rotation and a toothing running around the axis of rotation with teeth and tooth spaces arranged alternately in a circumferential direction around the axis of rotation, wherein the toothing has at least one axial end face with a recess running around the axis of rotation. Each of the teeth can thus have a first section and a second section that is axially offset to the rear in relation to the first section. The toothing is preferably radially limited on the one hand by a root circle diameter and on the other hand by an addendum circle diameter. The recess can therefore be cut from the tooth spaces. Preferably, the toothing is designed as external toothing, so that the toothing is preferably limited radially outwards by the addendum circle diameter and radially inwards by the root circle diameter. Unless otherwise stated, the terms “radial” and “axial” here and in the following refer to the axis of rotation.

According to the invention, the at least one thrust washer has at least one washer projection projecting radially beyond the thrust surface, and is arranged in the recess in such a way that the at least one washer projection is arranged to engage radially in one of the tooth spaces in each case. As a result, the at least one thrust washer can be easily manufactured and arranged on the gear in a single manufacturing step to prevent it from turning. The at least one thrust washer can thus be arranged on the gear in such a way that the at least one washer projection is supported on a tooth flank radially adjacent to the recess. This means that no additional securing structure, such as a securing groove, particularly an axial one, is required on the side of the gear. Preferably, the at least one washer projection is arranged to engage exclusively radially in one of the tooth spaces. The description of the thrust surface as essentially annular describes that, in particular, a shoulder undercut of the at least one washer projection can intersect the thrust surface.

Preferably, the at least one end face has at least one shoulder radially delimiting the recess. The at least one shoulder is preferably annular in shape. Preferably, the at least one end face has exactly one shoulder.

The at least one shoulder preferably has a shoulder diameter, wherein the shoulder diameter is particularly preferably smaller than the addendum circle diameter of the toothing and larger than the root circle diameter of the toothing. The shoulder can thus be cut from tooth spaces.

The at least one shoulder can be arranged to limit the recess radially inwards and/or the recess radially outwards. Preferably, the at least one washer projection is designed to project radially inwards and/or radially outwards over the thrust surface in accordance with the arrangement of the at least one shoulder. It is particularly preferred that the at least one shoulder is arranged so as to limit the recess exclusively inwards. In this case, the respective first section of the teeth is arranged radially within the respective second section of the teeth.

The toothing can have a tooth height and the at least one shoulder can have a shoulder height, wherein the ratio of the shoulder height to the tooth height is 0.05 to 0.3 and preferably 0.05 to 0.15. Here and in the following, the tooth height is preferably understood as the difference between the addendum circle diameter and the root circle diameter. Here and in the following, the shoulder height preferably refers to the difference between the shoulder diameter and the root circle diameter in the event that the toothing is designed as external toothing, or the difference between the shoulder diameter and the addendum circle diameter in the event that the toothing is designed as internal toothing. An axial shoulder width of the at least one shoulder preferably corresponds essentially to an axial washer width of the at least one thrust washer.

In a preferred embodiment of the invention, the toothed wheel and the at least one thrust washer are connected to each other exclusively by a positive connection. The at least one thrust washer can have radial and axial play in relation to the gear.

This means that there is preferably no frictional connection between the at least one thrust washer and the gear. In particular, this allows the at least one thrust washer to be arranged on the gear without chip out or deformation of the at least one thrust washer.

In a further development of the invention, a projection contour of the at least one washer projection is mathematically similar, at least in sections, to a space contour of one of the tooth spaces. This can reduce the mobility of the at least one thrust washer in relation to the gear, particularly in the circumferential direction. Preferably, the projection contour is similar to the section of the space contour in which the washer projection is arranged to engage. In particular, the projection contour can be designed similarly in such a way that it is centrally compressed compared to the corresponding section of the space contour. This allows an appropriate clearance of at least one thrust washer in relation to the gear to be achieved. The at least one thrust washer can have several washer projections. Each of the washer projections preferably has the features of the at least one washer projection described above. Preferably, the at least one thrust washer has three to nine of the washer projections. The washer projections are preferably arranged at regular intervals from one another in the circumferential direction.

In a further development of the invention, the gear has at least one radial bearing seat arranged axially adjacent to the toothing. Preferably, the at least one radial bearing seat is arranged axially adjacent to the toothing, wherein a bearing seat undercut can be arranged between the toothing and the radial bearing seat. The at least one radial bearing seat is preferably cylindrical. Preferably, the gear is designed as a single piece.

According to a preferred embodiment, the gear is designed as a spindle nut. Preferably, the spindle nut has a threaded through-hole formed along the axis of rotation to accommodate a threaded spindle.

In a further embodiment of the invention, a first thrust washer of the at least one thrust washer is arranged on a first end face of the at least one end face, and a second thrust washer of the at least one thrust washer is arranged on a second end face of the at least one end face, wherein the second end face is arranged axially opposite the first end face. This allows the gear to be supported axially on both sides of the toothing.

A drive according to the invention, in particular for an adjustment device for a motor vehicle, comprises the gear assembly described above.

The drive preferably has at least one plain bearing, with the at least one plain bearing having an axial bearing section which is arranged axially adjacent to the thrust surface of the at least one thrust washer. Axial forces acting on the gear can thus be supported via the at least one thrust washer and the plain bearing. The axial bearing section can be arranged on a drive housing of the drive with a bearing rear face arranged axially opposite the thrust surface.

In a preferred embodiment, the at least one plain bearing has a radial bearing section formed at right angles to the axial bearing section, wherein the radial bearing section is arranged in contact with the at least one radial bearing seat, and wherein
an axial inner diameter of the axial bearing section is greater than/equal to a thrust surface inner diameter of the thrust surface, and/or
an axial outer diameter of the axial bearing section is less than/equal to a thrust surface outer diameter of the thrust surface.

The axial inner diameter and the axial outer diameter preferably limit the contact surface of the at least one plain bearing, which is intended for contact with the interface of an object to be axially supported, in particular the thrust surface of the at least one thrust washer. In the half section, the at least one plain bearing can be L-shaped. The at least one plain bearing can be designed in such a way that the radial bearing section and axial bearing section are each arranged adjacent to a chamfer connecting the radial bearing section to the axial bearing section.

An adjustment device according to the invention for a motor vehicle, in particular for a motor vehicle seat, comprises the drive described above. Preferably, the adjustment device is designed as a seat fore-and-aft adjustment device, in particular for a motor vehicle seat.

Examples of embodiments of the invention are explained with reference to the following figures. In the figures:

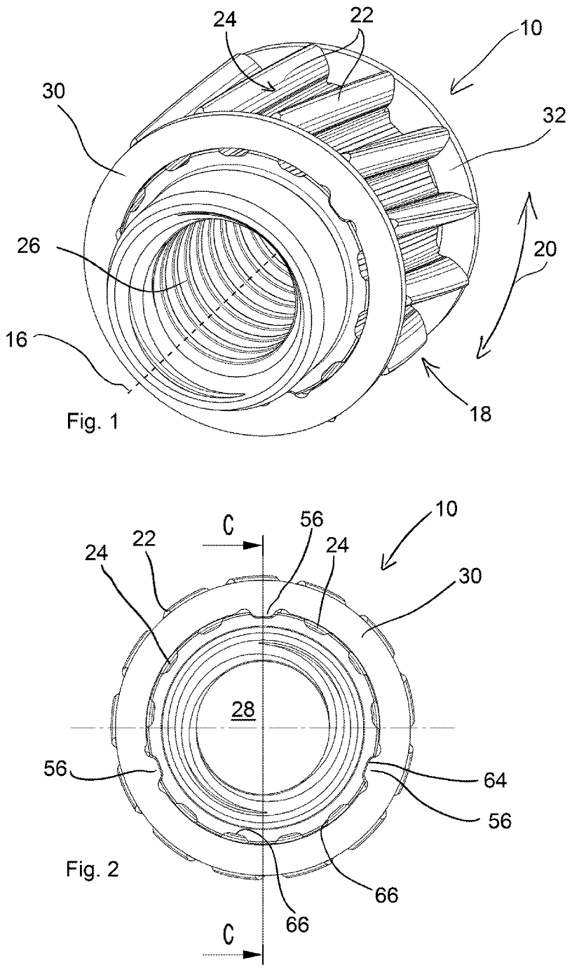

FIG. 1 is a perspective view of a design example of a gear assembly with a spindle nut and two thrust washers,

FIG. 2 is a frontal side view of the embodiment shown in FIG. 1 with the sectional plane C-C indicated,

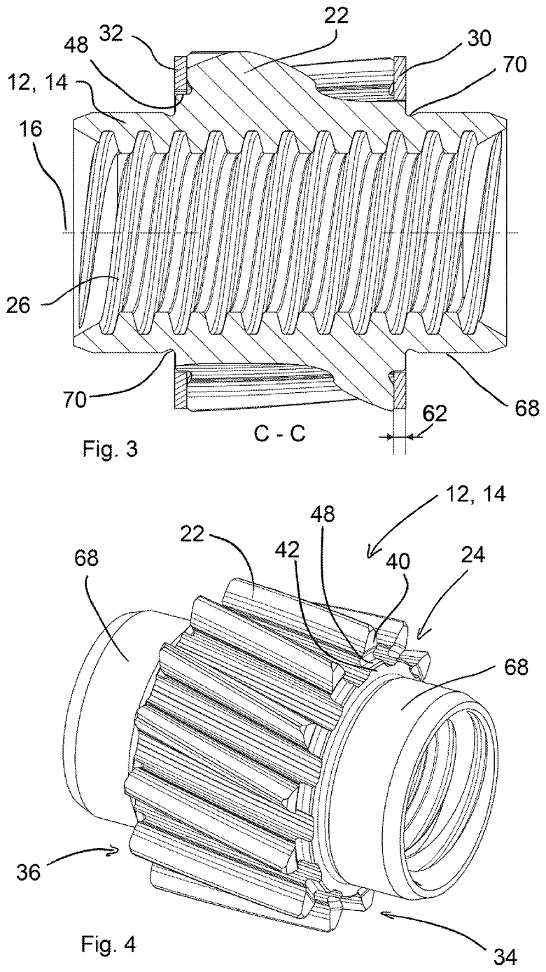

FIG. 3 is a sectional view of the embodiment shown in FIG. 1 along the sectional plane C-C shown in FIG. 2,

FIG. 4 is a perspective view of the spindle nut of the embodiment shown in FIG. 1,

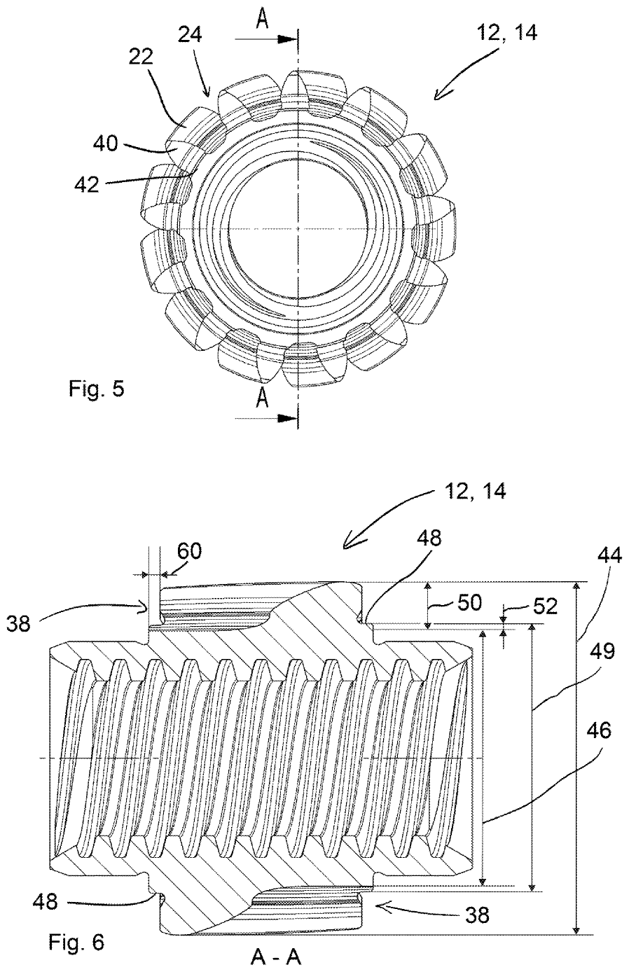

FIG. 5 is a frontal side view of the spindle nut shown in FIG. 4 with the marked sectional plane A-A,

FIG. 6 is a sectional view of the spindle nut shown in FIG. 4 along the sectional plane A-A shown in FIG. 5,

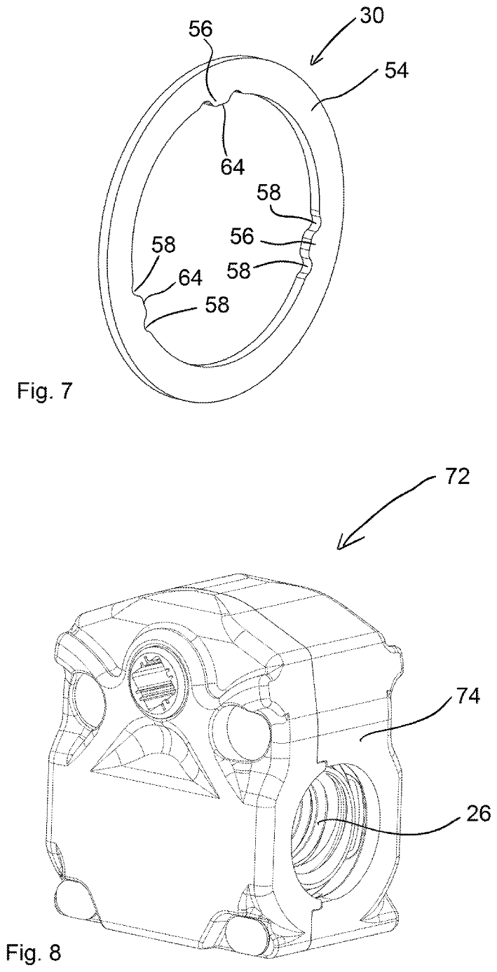

FIG. 7 is a perspective view of one of the thrust washers of the embodiment shown in FIG. 1,

FIG. 8 is a perspective view of a design example of a drive with a spindle nut and an axis of rotation,

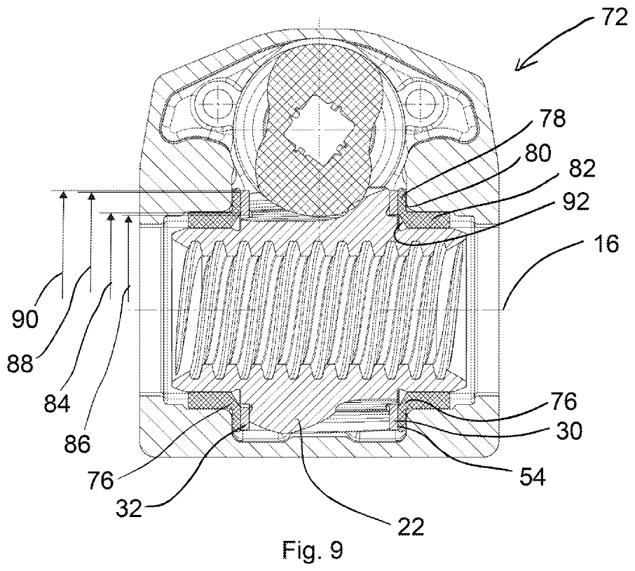

FIG. 9 is a longitudinal section of the embodiment shown in FIG. 8 along the axis of rotation.

FIGS. 1 to 9 are various embodiments. The same reference symbols are used for identical and functionally identical parts. For the sake of clarity, not all reference symbols are used in every figure.

FIG. 1 is a perspective view of a gear assembly 10 with a gear 14 designed as a spindle nut 12. The spindle nut 12 has an axis of rotation 16 and a toothing 18 rotating around the axis of rotation 16 with teeth 22 and tooth spaces 24 arranged alternately in a circumferential direction 20 around the axis of rotation 16. The toothing 18 is designed as external toothing. The spindle nut 12 also has a through-hole 28 formed along the axis of rotation 16 and having a thread 26 to accommodate a threaded spindle. As FIG. 1 also displays, the gear assembly 10 comprises a first thrust washer 30 and a second thrust washer 32.

FIG. 4-6 are separate illustrations of the spindle nut 12. It can be seen from this that the toothing 18 has an axial first end face 34 and an axial second end face 36 arranged opposite the first end face 34. The first end face 34 and the second end face 36 each have a recess 38 running around the axis of rotation 16. Each of the teeth 22 can thus have a first section 40 and a second section 42 that is axially recessed with respect to the first section 40. The toothing 18 is limited radially outwards by an addendum circle diameter 44 and radially inwards by a root circle diameter 46 (FIG. 6). FIG. 4 demonstrates that the respective recess 38 is thus cut from the tooth spaces 24.

In particular, FIGS. 4 and 6 show that each of the end faces 34, 36 has an annular ring-shaped shoulder 48 radially delimiting the respective recess 38. The shoulder 48 has a shoulder diameter 49 that is smaller than the addendum circle diameter 44 and larger than the root circle diameter 46. The shoulder 48 is thus cut from the tooth spaces 24.

On both end faces 34, 36, the shoulder 48 is arranged radially inwardly limiting the recess 38. The shoulder 48 limits the recess 38 exclusively radially inwards. Accordingly, the respective first section 40 of the teeth 22 is arranged radially within the respective second section 42 of the teeth 22.

As FIG. 6 shows, the toothing 18 has a tooth height 50 and the shoulder 48 has a shoulder height 52, the ratio of the shoulder height 52 to the tooth height 50 being 0.05 to 0.3 and preferably 0.05 to 0.15. The illustration in FIG. 6 also shows that in the embodiment example shown, the tooth height 50 corresponds to the difference between the addendum circle diameter 44 and the root circle diameter 46 and the shoulder height 52 corresponds to the difference between the shoulder diameter 49 and the root circle diameter 46.

A separate illustration of the first thrust washer 30 can be found in FIG. 7. The first thrust washer 30 and the second thrust washer 32 are preferably of identical design. As can also be seen from FIGS. 1 and 2, the first thrust washer 30 and the second thrust washer 32 each have a substantially annular thrust surface 54 and three washer projections 56 projecting radially inwards beyond the thrust surface 54. In this case, shoulder undercuts 58 of the washer projections 56 cut radially in the thrust surface 54.

The first thrust washer 30 is arranged in the recess 38 of the first end face 34 in such a way that each of the washer projections 56 is arranged to engage radially in one of the tooth spaces 24. The thrust washers 30, 32 are thus arranged on the spindle nut 12 in such a way that the washer projections 56 are supported on a tooth flank radially adjacent to the respective recess 38. As the sectional view in FIG. 3 shows, the washer projections 56 are arranged to engage exclusively radially in one of the tooth spaces 24 in each case. It can also be seen from the illustration in FIG. 3 that an axial shoulder width 60 of the respective shoulder 48 essentially corresponds to an axial washer width 62 of the respective thrust washer 30, 32.

The spindle nut 12 and the thrust washers 30, 32 are only positively connected to each other. The thrust washers 30, 32 can have radial and axial play in relation to the spindle nut 12.

Each of the washer projections 56 has a projection contour 64 (see FIG. 7). It can be seen from the illustration in FIG. 2 that the projection contour 64 is mathematically similar, at least in sections, to a space contour 66 which each of the tooth spaces 26 has. The projection contour 64 is similar to the section of the space contour 66 in which the respective washer projection 56 is arranged to engage. In particular, the projection contour 64 is similarly formed in such a way that it is centrally compressed in comparison to the corresponding section of the space contour 66.

This ensures that the thrust washers 30, 32 have adequate play in relation to the spindle nut 12.

As shown in particular in FIGS. 1, 3, 4 and 6, the spindle nut 12 has radial bearing seats 68 arranged axially adjacent to the toothing 18 on both sides. The radial bearing seats 68 are each arranged axially adjacent to the toothing 18, with a bearing seat undercut 70 being arranged between the toothing 18 and the radial bearing seats 68. The radial bearing seats 68 are cylindrical formed. The spindle nut 12 is formed in one piece.

FIG. 8 is a drive 72 for a seat fore-and-aft adjustment device for a motor vehicle seat. The drive 72 comprises a drive housing 74 and the gear assembly 10 described above. In the illustration in FIG. 8, the through-hole 28 of the spindle nut 12 is visible. As the sectional view in FIG. 9 shows, the drive 72 has two plain bearings 76. Each of the plain bearings 76 has an axial bearing section 78, which is arranged axially adjacent to the thrust surface 54 of the respective thrust washer 30, 32. Axial forces acting on the spindle nut 12 can thus be supported via the thrust washers 30, 32 and the plain bearings 76. For this purpose, the respective axial bearing section 78 is arranged on the drive housing 74 with a bearing rear face 80 arranged axially opposite the thrust surface 54.

In addition, the plain bearings 76 each have a radial bearing section 82 formed at right angles to the axial bearing section 78, the respective radial bearing section 82 being arranged in contact with one of the radial bearing seats 68. Here, an axial inner diameter 84 of the axial bearing section 78 is greater than or equal to a thrust surface inner diameter 86 of the thrust surface 54, and an axial outer diameter 88 of the axial bearing section 78 is less than or equal to a thrust surface outer diameter 90 of the thrust surface 54.

The axial inner diameter 84 and the axial outer diameter 88 preferably limit the contact surfaces of the plain bearings 76, which are provided for contact with the thrust surfaces 54 of the thrust washer 30, 32. As the view in FIG. 9 shows, the plain bearings 76 are each L-shaped in the half section. The radial bearing section 82 and the axial bearing section 78 are each arranged adjacent to a chamfer 92 connecting the radial bearing section 82 to the axial bearing section 78.

### LIST OF REFERENCE NUMBERS

10 gear assembly
12 spindle nut
14 gear
16 axis of rotation
18 toothing
20 circumferential direction
22 tooth
24 tooth space
26 thread
28 through-hole
30 first thrust washer
32 second thrust washer
34 first end face
36 second end face
38 recess
40 first section
42 second section
44 addendum circle diameter
46 root circle diameter
48 shoulder
49 shoulder diameter
50 tooth height
52 shoulder height
54 thrust surface
56 washer projection
58 shoulder undercut
60 shoulder width
62 washer width
64 projection contour
66 space contour
68 radial bearing seat
70 bearing seat undercut
74 drive housing
76 plain bearing
78 axial bearing section
80 bearing rear face
82 radial bearing section
84 axial inner diameter
86 thrust surface inner diameter
88 axial outer diameter
90 thrust surface outer diameter
92 chamfer

1. A gear assembly (10) with a gear (14) and at least one thrust washer (30, 32) with a substantially annular thrust surface (54), wherein the gear (14) has an axis of rotation (16) and a toothing (18) running around the axis of rotation (16) with teeth (22) and tooth spaces (24) arranged alternately in a circumferential direction (20) around the axis of rotation (16), wherein the toothing (18) has at least one axial end face (34, 36) with a recess (38) running around the axis of rotation (16), characterized in that
the at least one thrust washer (30, 32) has at least one washer projection (56) projecting radially beyond the thrust surface (54) and is arranged in the recess (38) in such a way that the at least one washer projection (56) is arranged to engage radially in one of the tooth spaces (24) in each case.

2. The gear assembly according to claim 1,
characterized in that
the at least one end face (34, 36) has at least one shoulder (48) radially delimiting the recess (38).

3. The gear assembly according to claim 2,
characterized in that
the at least one shoulder (48) has a shoulder diameter (49), wherein the shoulder diameter (49) is smaller than an addendum circle diameter of the toothing (18) and larger than a root circle diameter (46) of the toothing (18).

4. The gear assembly according to claim 2,
characterized in that
the at least one shoulder (48) is arranged radially inwardly of the recess (38) and/or radially outwardly of the recess (38).

5. The gear assembly according to claim 2,
characterized in that
the toothing (18) has a tooth height (50) and the at least one shoulder (48) has a shoulder height (52) wherein the ratio of the shoulder height (52) to the tooth height (50) is 0.05 to 0.3 and preferably 0.05 to 0.15.

6. The gear assembly according to claim 1,
characterized in that
the gear (14) and the at least one thrust washer (30, 32) are connected to each other exclusively by a form-fitting connection.

7. The gear assembly according to claim 1,
characterized in that
a projection contour (64) of the at least one washer projection (56) is designed, at least in sections, to be mathematically similar to a space contour (66) of one of the tooth spaces (24).

8. The gear assembly according to claim 1,
characterized in that
the at least one thrust washer (30, 32) has several washer projections (56).

9. The gear assembly according to claim 1,
characterized in that
the gear (14) has at least one radial bearing seat (68) arranged axially adjacent to the gearing (18).

10. The gear assembly according to claim 1,
characterized in that
the gear (14) is designed as a spindle nut (12).

11. The gear assembly according to claim 1,
characterized in that
a first thrust washer (30) of the at least one thrust washer (30, 32) is arranged on a first end face (34) of the at least one end face (34, 36) and a second thrust washer (32) of the at least one thrust washer (30, 32) is arranged on a second end face (36) of the at least one end face (34, 36), wherein the second end face (36) is arranged axially opposite the first end face (34).

12. A drive (72), in particular for an adjustment device for a motor vehicle, comprising a gear assembly (10) according to claim 1.

13. The drive according to claim 12,
characterized in that
the drive (72) has at least one plain bearing (76), wherein the at least one plain bearing (76) has an axial bearing section (78) which is arranged axially adjacent to the thrust surface (54) of the at least one thrust washer (30, 32).

14. The drive according to claim 12,
wherein the gear assembly is formed,
characterized in that
the at least one plain bearing (76) comprises a radial bearing section (82) formed perpendicular to the axial bearing section (78), wherein the radial bearing section (82) is arranged abutting against the radial bearing seat (68), and wherein
an axial inner diameter (84) of the axial bearing section (78) is greater than/equal to a thrust surface inner diameter (86) of the thrust surface (54), and/or
an axial outer diameter (88) of the axial bearing section (78) is less than/equal to a thrust surface outer diameter (90) of the thrust surface (54).

15. Adjustment device for a motor vehicle, in particular for a motor vehicle seat, comprising a drive (72) according to claim 12.
